(19) United States
(12) Patent Application Publication
(10) Pub. No.: US 2026/0350944 A1
(43) Pub. Date: Nov. 5, 2026

(54) IMAGE EDITING WITH 3D TRANSFORMATIONS USING 3D PRIORS

(71) Applicant: ADOBE INC., SAN JOSE, CA (US)

(72) Inventors: Yen-Chi Cheng, Champaign, IL (US); Nanxuan Zhao, San Jose, CA (US); Paul Guerrero, London (GB); Matheus Gadelha, San Jose, CA (US); Jae Shin Yoon, San Jose, CA (US); Krishna Kumar Singh, San Jose, CA (US)

(21) Appl. No.: 19/196,422

(22) Filed: May 1, 2025

(51) Int. Cl. G06T 19/20; G06T 17/00

(52) U.S. Cl. CPC G06T 19/20; G06T 17/00; G06T 2219/2016

(57) ABSTRACT

A method, apparatus, non-transitory computer readable medium, and system for applying 3D edits to an input image includes first obtaining an input image and an edit command. The input image depicts an object, and the edit command describes a transformation of the object, such as an out-of-plane rotation. The system then generates, using a 3D modelling network, a 3D model of the object based on the input image. Then, the system transforms the 3D model based on the edit command to obtain a modified 3D model. Embodiments of the system then generate, using an image generation model, a synthetic image based on the modified 3D model. The synthetic image depicts the transformation applied to the object and preserves an identity of the object from the input image.

### BACKGROUND

The following relates generally to image processing, and more specifically to generative image editing. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Recently, advances in machine learning (ML) techniques have enabled new approaches to image editing that use generative models. These models can create realistic images based on input data and editing instructions. In particular, diffusion models have shown impressive results in generating high-quality images with detailed features. Diffusion models work by gradually adding noise to training images and then learning to reverse the process. Users may provide additional conditions to the editing process such as text descriptions to guide the generation process. In some cases, users may wish to make edits to objects within images, such that the edited objects are seamlessly harmonized with the rest of the image. Such edits may include changes to object appearance, position, or orientation within the scene.

### SUMMARY

Embodiments of the present disclosure include systems and methods for applying three-dimensional (3D) edits to objects within an image. Embodiments include an image processing apparatus configured to receive and process an input image that depicts an object and a transformation instruction. The system may identify the object using segmentation techniques, or a user may specify the object via a user interface. Embodiments of the system generate a 3D shape of the object, applies the transform to the 3D shape, and rasterize the transformed 3D shape into the input image to generate a 3D guidance image. In some cases, the system further generates a grayscale mask with pixel values indicating 1) the hole left by removing and transforming the object, 2) the pixels corresponding to the 3D shape, and 3) the original undisturbed pixels from the input image. An image generation model specifically trained to process the 3D guidance image and the mask then generates a synthetic image depicting the object with the 3D transformation.

A method, apparatus, non-transitory computer readable medium, and system for generative image editing are described. One or more aspects of the method, apparatus, non-transitory computer readable medium, and system include obtaining an input image and an edit command, wherein the input image depicts an object and the edit command describes a transformation of the object; generating, using a 3D modelling network, a 3D model of the object based on the input image; transforming the 3D model based on the edit command to obtain a modified 3D model; and generating, using an image generation model, a synthetic image based on the modified 3D model, wherein the synthetic image depicts the transformation applied to the object and preserves an identity of the object from the input image.

A method, apparatus, non-transitory computer readable medium, and system for generative image editing are described. One or more aspects of the method, apparatus, non-transitory computer readable medium, and system include obtaining an input image depicting an object; performing a 3D transformation of the object based on the input image to obtain a 3D guidance image; and generating, using an image generation model, a synthetic image based on the 3D guidance image, wherein the synthetic image depicts the 3D transformation of the object.

An apparatus, system, and method for generative image editing are described. One or more aspects of the apparatus, system, and method include a memory component; a processing device coupled to the memory component, the processing device configured to perform operations comprising: obtaining an input image and an edit command, wherein the input image depicts an object and the edit command describes a transformation of the object; generating a 3D model of the object based on the input image; transforming the 3D model based on the edit command to obtain a modified 3D model; and generating, using an image generation model, a synthetic image based on the modified 3D model, wherein the synthetic image depicts the transformation applied to the object and preserves an identity of the object from the input image.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a guided latent diffusion model according to aspects of the present disclosure.

FIG. 4 shows an example of a U-Net architecture according to aspects of the present disclosure.

FIG. 5 shows an example of a diffusion transformer (DiT) architecture according to aspects of the present disclosure.

FIG. 6 shows an example of a pipeline for editing images with 3D transformations according to aspects of the present disclosure.

FIG. 7 shows an example diffusion process according to aspects of the present disclosure.

FIG. 8 shows an example of a method for generating a synthetic image depicting a 3D edit according to aspects of the present disclosure.

FIG. 9 shows an example of a training data generation pipeline according to aspects of the present disclosure.

FIG. 10 shows an example of a transform estimation pipeline according to aspects of the present disclosure.

FIG. 11 shows an example of an image generation model training pipeline according to aspects of the present disclosure.

FIG. 12 shows an example of training tuples according to aspects of the present disclosure.

FIG. 13 shows an example of a step-by-step algorithm for training a machine learning (ML) model according to aspects of the present disclosure.

FIG. 14 shows an example of a method for training a diffusion model according to aspects of the present disclosure.

FIG. 15 shows an example of results from present embodiments and other approaches according to aspects of the present disclosure.

FIG. 16 shows an example of a computing device according to aspects of the present disclosure.

### DETAILED DESCRIPTION

Image processing techniques, such as image generation, are frequently used in creative workflows. Historically, users would rely on manual techniques and drawing software to create visual content. The advent of machine learning (ML) has enabled new workflows that automate the image creation process. These ML-based workflows can significantly reduce the time and technical expertise required to produce complex visual content, allowing creators to focus more on ideation and less on manual execution.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Image editing is one common application of image processing. Traditional image editing involves manual manipulation of pixel data using software tools such as brushes, selection tools, and filters. Users might adjust colors, remove unwanted elements, or modify specific regions of an image. These operations typically require significant user expertise and time to achieve professional-quality results. For more complex edits, users may need to carefully select objects, create masks, and make pixel-by-pixel adjustments to ensure the edits appear natural within the context of the image.

Recently, generative ML techniques have been applied to image editing. Methods such as inpainting allow users to remove unwanted objects from images and automatically fill the resulting holes with plausible content that matches the surrounding context. Other generative techniques can transform image styles, add new elements to scenes, or enhance image quality. These approaches reduce the manual effort required for complex edits while often producing more realistic results than traditional techniques. In some cases, users may want to make edits to a particular object within the image. For example, a user might want to change the position, orientation, or size of an object while maintaining its visual appearance and ensuring it integrates naturally with the rest of the image.

Some conventional approaches to image editing allow users to input drag-based edits for translations and rotations. These methods enable users to select points on an object and drag them to new positions, with the system automatically adjusting the object accordingly. However, these approaches are typically limited to in-plane transformations and often struggle with maintaining visual consistency when significant edits are applied.

Some methods allow users to instruct the models with natural language texts, providing a more intuitive interface for specifying edits. While these text-based approaches offer flexibility, they can lack precision for specific geometric transformations. Furthermore, the underlying models in the available text-instruction methods can fail to persist the details from the original image or generate implausible and inaccurate content due to their training, which is not based on 3D edits.

Some methods allow users to provide 3D instructions for image editing; however, these models are trained on synthetic shape data and can generate implausible content for real-world objects. These methods may fail to properly handle lighting, shadows, and texture details that are needed for photorealistic editing. Additionally, some conventional methods that do support 3D transformations rely on computationally expensive optimization processes during inference time. This significantly increases processing time and resource requirements, making them impractical for many real-world applications; such as real-time editing. Furthermore, these methods typically struggle with handling occluded regions that become visible after 3D transformations, resulting in noticeable artifacts or implausible content generation.

Embodiments of the present disclosure improve the accuracy of generative image editing systems by implementing an image generation model that infers synthetic images based on “3D priors.” The 3D priors are sometimes referred to as “3D guidance images” herein. Embodiments include an image processing apparatus configured to receive and process an input image that depicts an object and a transformation instruction. The system may identify the object using segmentation techniques, or a user may specify the object via a user interface. Embodiments of the system generate a 3D shape of the object, apply the transformation to the 3D shape, and rasterize the transformed 3D shape into the input image to generate a 3D guidance image. These 3D edits are not limited to simple scaling and 2D rotations but can include complex transformations such as out-of-plane rotations that reveal previously unseen portions of the object. An image generation model specifically trained to process the 3D guidance image then generates a synthetic image depicting the object with the 3D transformation. According to some aspects, the image generation model is finetuned from a video generation foundation model, which due to the nature of its pretraining on video data, includes a base knowledge about realistic objects in various positions and orientations even before the finetuning, further increasing the accuracy of synthesized content.

As used herein, an “edit command” refers to a command from a user to transform an object within an image. As described above, the edit command may specify a 3D edit such as a rotation out of the plane of an input image. The edit command may be, for example, a rotation around the x-axis, y-axis, or z-axis by a specified number of degrees (e.g., “rotate 45 degrees around the y-axis”), a translation along any axis (e.g., “move object 10 pixels to the left”), a scaling operation (e.g., “make the object 20% larger”), or a combination of multiple transformations (e.g., “rotate 30 degrees around the z-axis and move 15 pixels upward”).

A user can specify the edit command through various interfaces. For example, the user may provide a natural language prompt describing the desired transformation (e.g., “rotate the cup to show its handle”). The user may manipulate a GUI widget such as sliders, dials, or 3D manipulation handles overlaid on the object. The user might click and drag on the object or specific control points to indicate translations and rotations. In some implementations, the user may directly enter numerical values for transformation parameters, such as angle delta values, translation distances, or transformation matrices. Other input methods may include gesture controls on touch screens, motion controls using a camera or depth sensor, sketching the desired transformation path, selecting from preset transformation templates, or using augmented reality interfaces to physically demonstrate the desired transformation in 3D space.

As used herein, a “transformation” refers to a translation, a scaling operation, or a rotation of an object depicted in the input image, within a 3D space. In some embodiments, the transformation includes an “out-of-plane” rotation made on an axis that is not orthogonal to the plane of the input image. Embodiments may interpret an edit command to obtain a transformation matrix that can be used to apply the transformation.

As used herein, a “3D model” refers to a representation of an object in a three-dimensional space. The 3D model can be manipulated by applying a transformation to it. For example, embodiments may transform a 3D model by applying a transformation matrix to the model, where the transformation matrix encodes the transformation. Some examples of a 3D model include point clouds, neural radiance field (NeRF) representations, voxels, and meshes, though embodiments are not limited thereto.

As used herein, an “image generation model” is a generative model configured to map inputs to an output synthetic image in pixel space. For example, an image generation model described herein may map inputs including an edit command and an input image to an output synthetic image. The “synthetic image” is an image generated by the image generation model that, for example, depicts an object from the input image, where the object is altered by the transformation specified in the edit command. According to some aspects, the object's identity is preserved between the input image and the synthetic image. This identity preservation ensures that visual characteristics, distinctive features, and recognizable attributes of the object remain consistent after the applied transformation, while only its pose, position, or scale are altered.

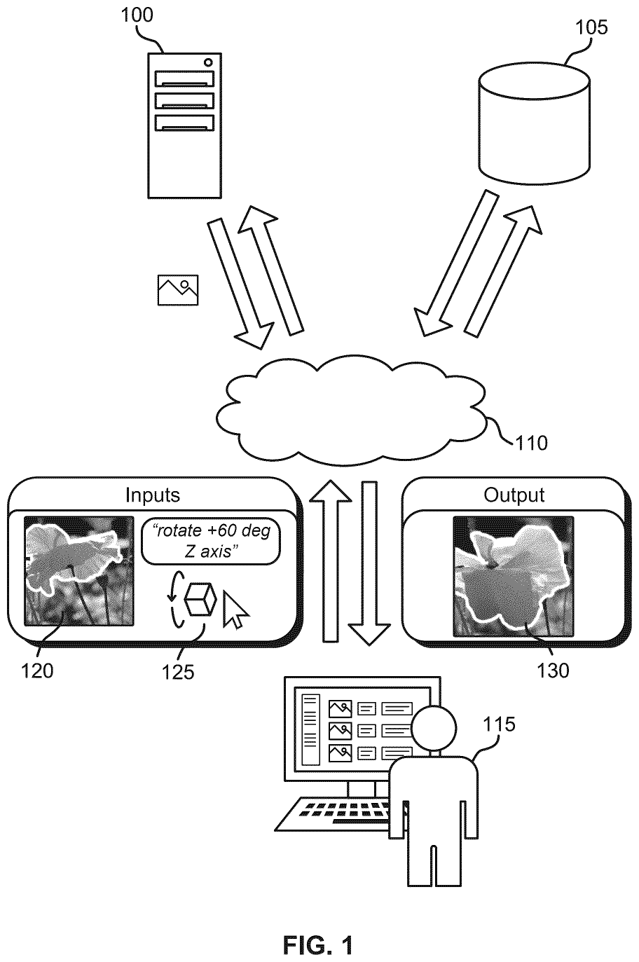

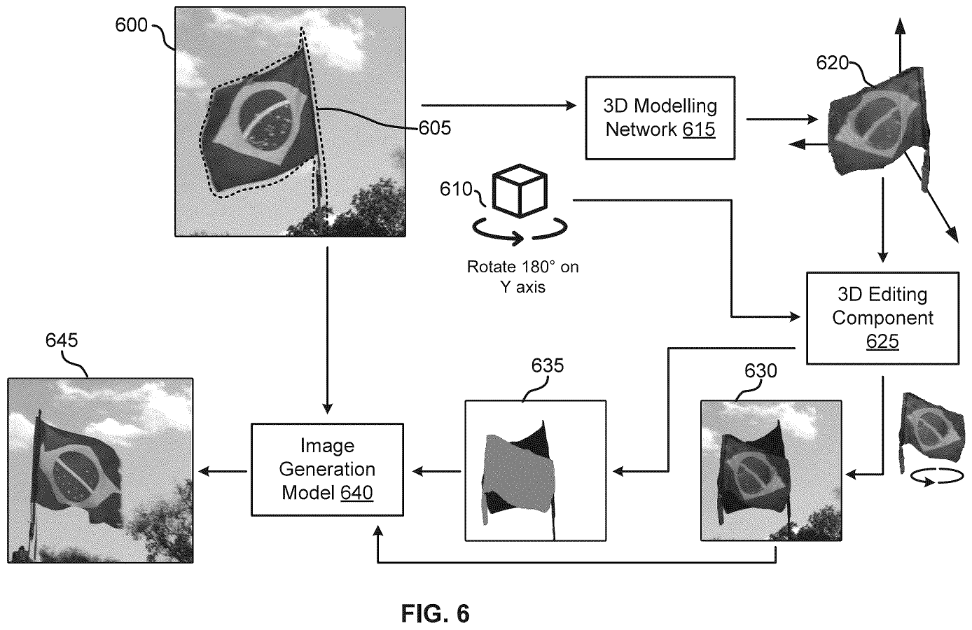

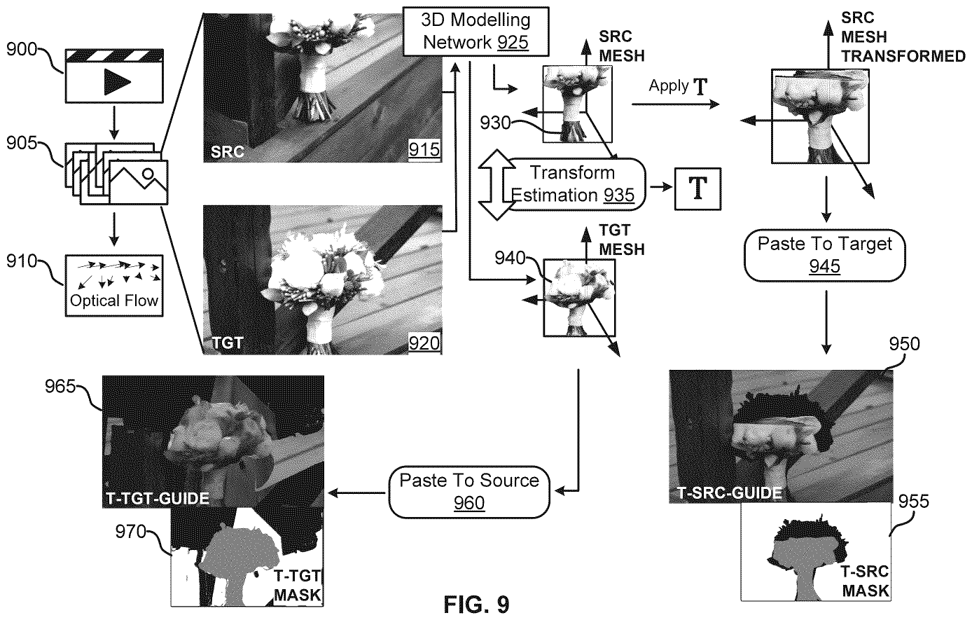

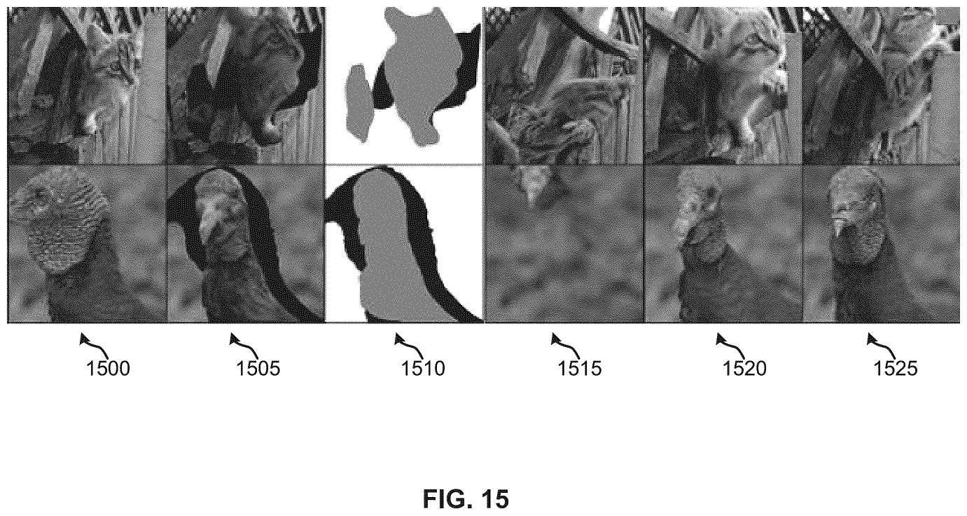

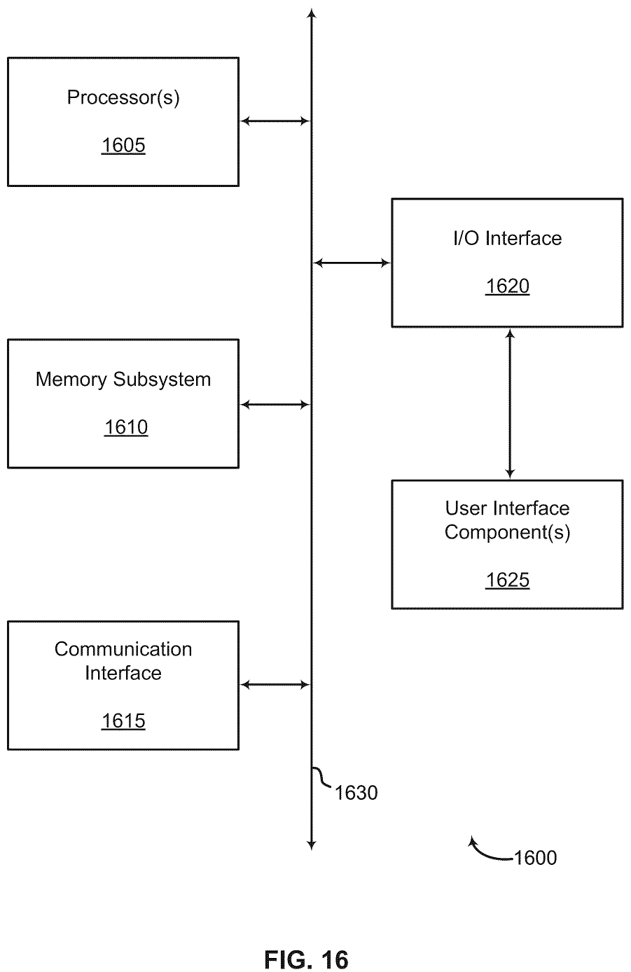

An image processing system is described with reference to FIGS. 1-5. Pipelines and methods for performing 3D edits on an input image are described with reference to FIGS. 6-8. Training methods and pipelines are described with reference to FIGS. 9-14. Some example results are described with reference to FIG. 15. A computing device configured to implement an image processing apparatus is described with reference to FIG. 16.

### Image Processing System

FIG. 1 shows an example of an image processing system according to aspects of the present disclosure. The example shown includes image processing apparatus 100, database 105, network 110, user 115, input image 120, 3D instruction 125, and synthetic image 130.

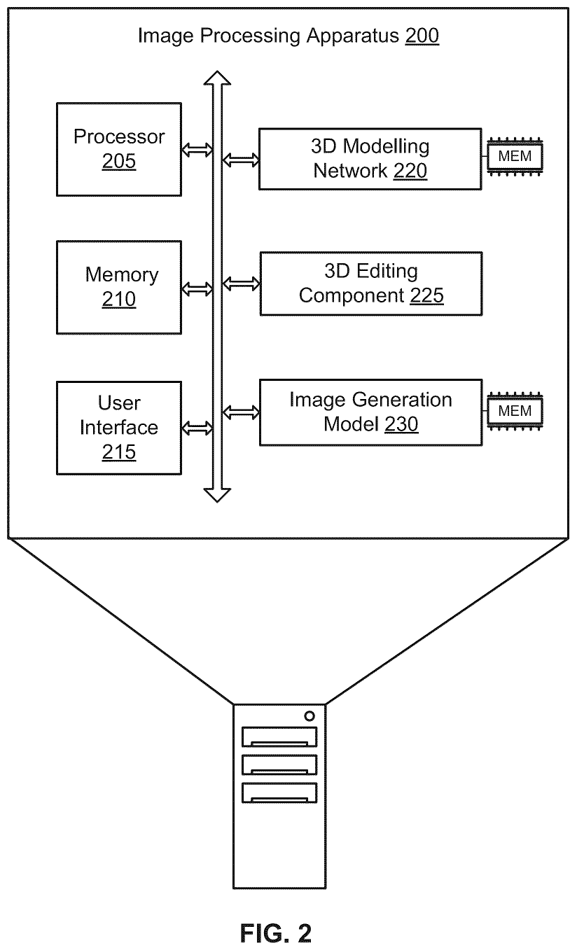

Image processing apparatus 100 is an example of, or includes aspects of, the corresponding element described with reference to FIG. 2. Input image 120 is an example of, or includes aspects of, the corresponding element described with reference to FIG. 6. 3D instruction 125 is an example of, or includes aspects of, the corresponding element described with reference to FIG. 6. Synthetic image 130 is an example of, or includes aspects of, the corresponding element described with reference to FIG. 6.

In one example, user 115 provides inputs including input image 120 and 3D instruction 125. The input image 120 may depict an object, and the 3D instruction 125 includes a transformation instruction for manipulating the object. The image processing apparatus 100 then processes input image 120 and 3D instruction 125 to form intermediate inputs including a 3D guidance image. The 3D guidance image is used to condition an image generation model to generate synthetic image 130, which is then provided to user 115 for e.g., approval or further edits.

In some embodiments, one or more components of image processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the image processing system. For example, database 105 may store model parameters, generated images, generated videos, intermediate representations and embeddings, user configuration settings, activity history, model training data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between image processing apparatus 100, database 105, and user 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image processing apparatus 200 according to aspects of the present disclosure. The example shown includes image processing apparatus 200, processor 205, memory 210, user interface 215, 3D modelling network 220, 3D editing component 225, and image generation model 230.

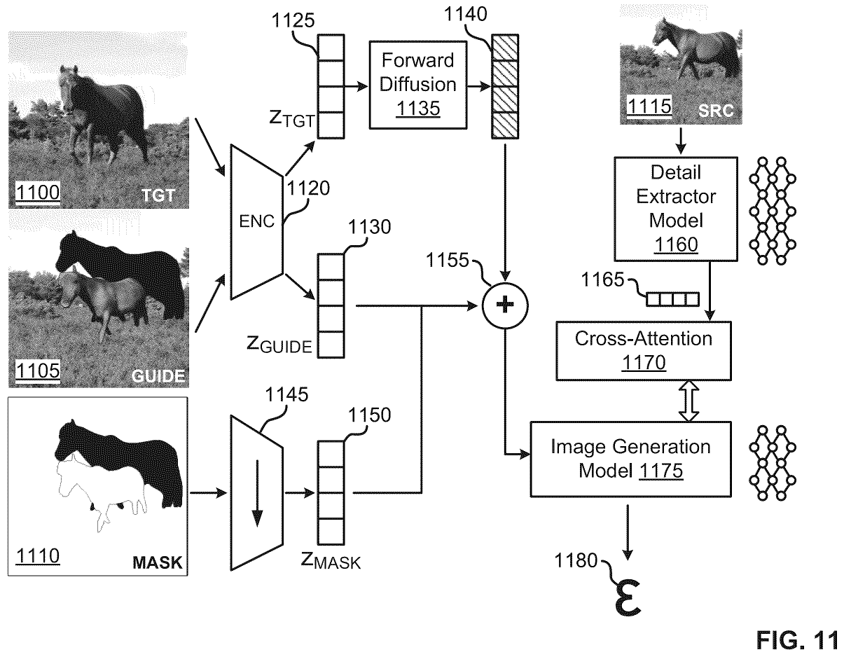

Image processing apparatus 200 is an example of, or includes aspects of, the corresponding element described with reference to FIG. 1. User interface 215 is an example of, or includes aspects of, the corresponding element described with reference to FIG. 1. 3D modelling network 220 is an example of, or includes aspects of, the corresponding element described with reference to FIGS. 6 and 9. 3D editing component 225 is an example of, or includes aspects of, the corresponding element described with reference to FIG. 6. Image generation model 230 is an example of, or includes aspects of, the corresponding element described with reference to FIGS. 6 and 11.

A processor 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 205 is configured to operate a memory array using a memory controller. In other cases, a memory controller is integrated into processor 205. In some cases, processor 205 is configured to execute computer-readable instructions stored in memory 210 to perform various functions. In some embodiments, processor 205 includes special purpose components for modem processing, baseband processing, digital signal processing, or transmission processing.

Memory 210 stores information used in the operation of image processing apparatus 200. Examples of a memory device include random access memory (RAM), read-only memory (ROM), or a hard disk. Examples of memory devices include solid state memory and hard disk drives. In some examples, memory 210 is used to store computer-readable, computer-executable software including instructions that, when executed, cause processor 205 to perform various functions described herein. In some cases, the memory 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 210 store information in the form of a logical state.

According to some aspects, some components of the image processing apparatus 200 may include dedicated memories as indicated by the ‘MEM’ elements in FIG. 2. These dedicated memories may store model parameters that, when combined with mathematical operations executed by processor 205, cause the corresponding components to perform the functions described herein. In some embodiments, the dedicated memories are implemented as non-transitory computer-readable mediums. The parameters may be stored statically or configured at runtime. For example, adjustments to the parameters may be made during pretraining processes, finetuning processes, or user-configuration processes such as hot-swapping different models. In certain implementations, these specialized memory structures enable hardware-accelerated execution of complex computational functions through purpose-built circuitry optimized for specific operations, thereby transforming the general-purpose computing device into a specialized machine uniquely configured to perform the particular image processing operations described herein. The dedicated memories may be coupled with specialized processing units, such as tensor processing units or neural processing units, which implement custom data paths specifically designed to execute the mathematical operations required by the image processing components.

A user interface 215 enables a user to interact with image processing apparatus 200. In some embodiments, user interface 215 includes an audio device, such as an external speaker system, an external display device such as a display screen, or an input device (e.g., remote control device interfaced with the user interface 215 directly or through an IO controller module). In some cases, user interface 215 includes a graphical user interface (GUI).

3D modelling network 220 is configured to transform a 2D image of an object into a 3D representation, such as a point cloud, voxels, meshes, neural radiance field (NeRF) or the like. In digital image processing and computer vision, transforming 2D images into 3D shapes involves reconstructing three-dimensional geometry from two-dimensional visual information. A 3D modelling network 220 can analyze input images and generate corresponding 3D representations. Examples include systems that produce mesh models, voxel grids, or neural implicit functions from single or multiple views. Techniques for this task include convolutional neural networks, transformer-based architectures, and sparse-view reconstruction models.

3D modelling network 220 may use a multi-stage pipeline to process input images. In some embodiments, the system extracts features from the input image, generates an intermediate representation such as a triplane encoding or voxel grid, and then converts this representation into an explicit 3D mesh through methods such as iso-surface extraction. These operations enable the transformation of pixel data into manipulable 3D geometry suitable for various applications.

Embodiments of the 3D modelling network 220 are trained on datasets including 3D geometry, depth maps, and normal maps. The network can operate on single images or multiple views and may incorporate operations such as feature extraction, coordinate mapping, and differentiable rendering. In some implementations, the system may also estimate camera parameters to align the generated 3D model with the input view.

3D modelling network 220 may also be configured to process a 2D image to generate tracking points for an object in the image, where the tracking points are based in a 3D space. In computer vision systems, tracking the correspondence of pixels or feature points between images enables various applications including motion analysis, structure reconstruction, and video processing. 3D modelling network 220 may include capabilities for identifying point correspondences between two or more images. These correspondences map the same physical point as it appears in different views or frames, allowing for spatial and temporal understanding of scene elements.

In some embodiments, the 3D modelling network 220 may include an additional trained model for tracking pixel points in 3D space across time, such as in frames of a video. The tracking model may utilize a triplane representation to encode 3D scene information, where image features are first lifted to 3D point clouds and then projected onto three orthogonal planes. This representation enables the efficient extraction of feature vectors at any 3D location. Accordingly, embodiments provide robust correspondence tracking even under challenging conditions such as occlusions or out-of-plane rotations.

According to some aspects, the tracking model (e.g., as part of the 3D modelling network 220) may be used to obtain 2D and 3D point correspondences from two frames of a video for use in generating training data. The system may use transformer architectures to predict motion updates iteratively and utilize 3D context to improve tracking accuracy. The model may also incorporate geometric constraints such as as-rigid-as-possible (ARAP) regularization or learn rigidity embeddings that group pixels exhibiting similar motion patterns. These techniques enable more reliable correspondence estimation compared to purely 2D approaches, for example, in scenarios involving complex deformations or self-occlusions.

Neural Radiance Fields (NeRF) and triplane tokens are techniques used to represent 3D models in computational imaging. NeRF uses a neural network to encode a volumetric scene, simulating how light travels through space and interacts with surfaces to produce highly realistic images from any viewpoint. This method models the color and density of points in a 3D space, which are used to render images with complex details and view-dependent effects. Triplane tokens simplify the representation of 3D spaces by projecting a version of the scene onto three orthogonal 2D planes-corresponding to XY, XZ, and YZ axes. These planes store encoded features that, when decoded, reconstruct the 3D properties such as color and density. This approach reduces computational requirements by transforming a 3D decoding problem into a combination of 2D tasks.

According to some aspects, 3D modelling network 220 generates a 3D model of the object based on the input image. In some aspects, the 3D model includes a point cloud, a frame mesh, a voxel representation, or a NeRF representation. In some examples, 3D modelling network 220 computes a transformation between the original state and the transformed state.

3D editing component 225 is configured to apply a 3D transformation (sometimes referred to herein as 3D transformation matrix ‘T’) to a 3D representation of a shape to transform it. The 3D representation may be a mesh, point cloud, voxel grid, or other 3D structure that represents the object identified in the input image. The transformation matrix T may be a 4×4 matrix that encodes both rotation and translation operations in a single mathematical representation. For rotation operations, the component applies the appropriate rotation matrix elements to each vertex or point in the 3D representation, rotating the entire structure around the specified axis by the specified angle. For translation operations, the component modifies the position coordinates of each point in the 3D space according to the translation parameters in matrix T. When scaling is included, the appropriate scaling factors are applied to the coordinates. In some implementations, the component may also handle more complex transformations such as shearing or non-uniform scaling.

In some cases, after applying the transformation, the 3D editing component 225 rasterizes the transformed 3D representation onto the input image, which forms the 3D guidance image. This process may include projecting the 3D points onto a 2D plane using a virtual camera with specified parameters, handling occlusions where parts of the 3D object block other parts and determining which portions of the transformed object are visible from the current viewpoint. The rasterization process may also apply appropriate shading based on lighting conditions to maintain visual consistency. In some implementations, the component may interpolate texture information from the original image onto the transformed 3D representation to preserve surface details in the guidance image.

According to some aspects, 3D editing component 225 performs a 3D transformation of the object based on the input image to obtain a 3D guidance image. In some examples, 3D editing component 225 transforms the 3D model based on an edit command to obtain a modified 3D model, where the 3D guidance image is based on the modified 3D model. In some examples, 3D editing component 225 generates a modified object image based on the modified 3D model, where the synthetic image is generated based on the modified object image.

Image generation model 230 is configured to generate images. According to some aspects, image generation model 230 may incorporate conditional information to influence its generation, such as additional images, text prompts, and other data modalities. Embodiments of the present concepts herein include systems for generating a 3D guidance image condition that, when combined with a specifically finetuned image generation model 230, enable accurate depictions of specified 3D edits.

Image generation models represent a class of machine learning systems designed to create new images based on learned patterns. These models analyze training data to understand visual characteristics and then produce novel images that reflect similar properties. Examples of image generation approaches include Variational Autoencoders (VAEs), Generative Adversarial Networks (GANs), and autoregressive models, each employing different techniques to generate visual content.

Recent image generation models 230 may implement a diffusion process, which gradually adds and then removes noise from data. This approach involves a forward process that incrementally adds noise to an image and a reverse process that learns to denoise images step by step. Diffusion models have demonstrated remarkable capabilities in producing high-quality, diverse images across various domains and conditions.

Some embodiments of the image generation model 230 use a CNN-based backbone, such as a U-Net diffusion model. The U-Net architecture, with its symmetric encoder-decoder structure and skip connections, effectively processes and generates visual information at multiple scales. In some cases, the image generation model 230 uses a transformer backbone, e.g., a Diffusion Transformer (DiT) model. These transformer-based approaches leverage self-attention mechanisms to capture long-range dependencies in visual data, often resulting in improved coherence and detail in the generated images.

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

A vision transformer (e.g., a ViT model) is a neural network model configured for computer vision tasks. Unlike CNNs, ViTs use a transformer architecture, which was originally developed for natural language processing (NLP) tasks. ViTs break down an input image into a sequence of patches, which are then fed through a series of transformer encoder layers. The output of the final encoder layer is fed into a multi-layer perceptron (MLP) head for classification. ViTs can capture long-range dependencies between patches without relying on spatial relationships. The detail extractor model described with reference to FIG. 11 may include a ViT model.

According to some aspects, image generation model 230 generates a synthetic image based on a modified 3D model, where the synthetic image depicts the transformation applied to the object and preserves an identity of the object from the input image. In some aspects, the image generation model 230 takes an input image, a 3D guidance image, and a masked image as input, where 3D guidance image includes the modified object image. In some aspects, the image generation model 230 is trained using video data that depicts a training object in an original state and a transformed state. In some aspects, the image generation model 230 is trained using a video frame consistency loss.

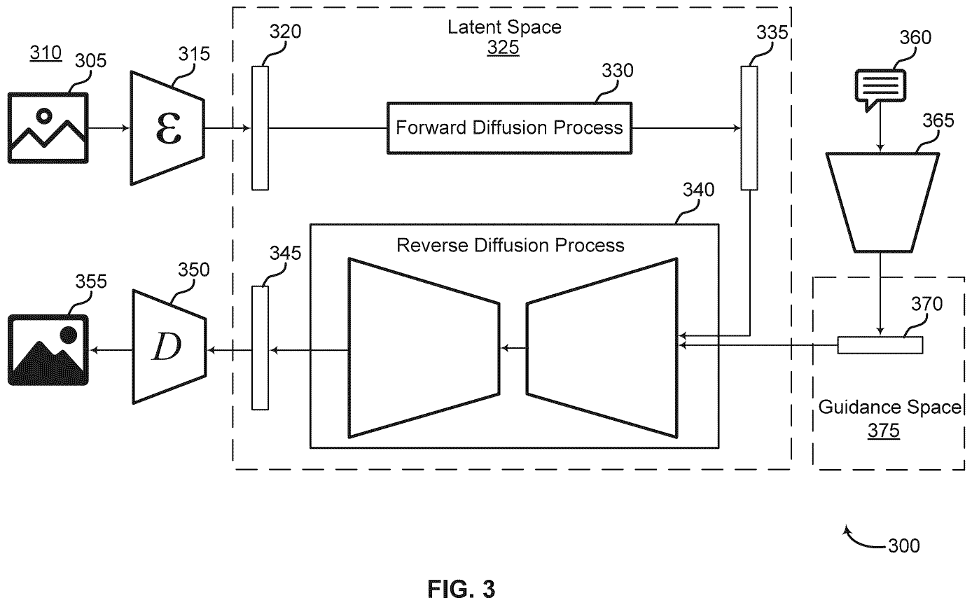

FIG. 3 shows an example of a guided latent diffusion model 300 according to aspects of the present disclosure. The guided latent diffusion model 300 depicted in FIG. 3 is an example of, or includes aspects of, the image generation model 230 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN or a diffusion transformer (DiT) ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and finetuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340. The process may be repeated to generate frames of a video or may be carried out on a spectrogram data and passed through a vocoder to generate sound. According to some aspects, diffusion models that are used to generate videos and/or sound may include additional architectural adaptations, such as temporal layers that ensure coherency between frames or waveforms.

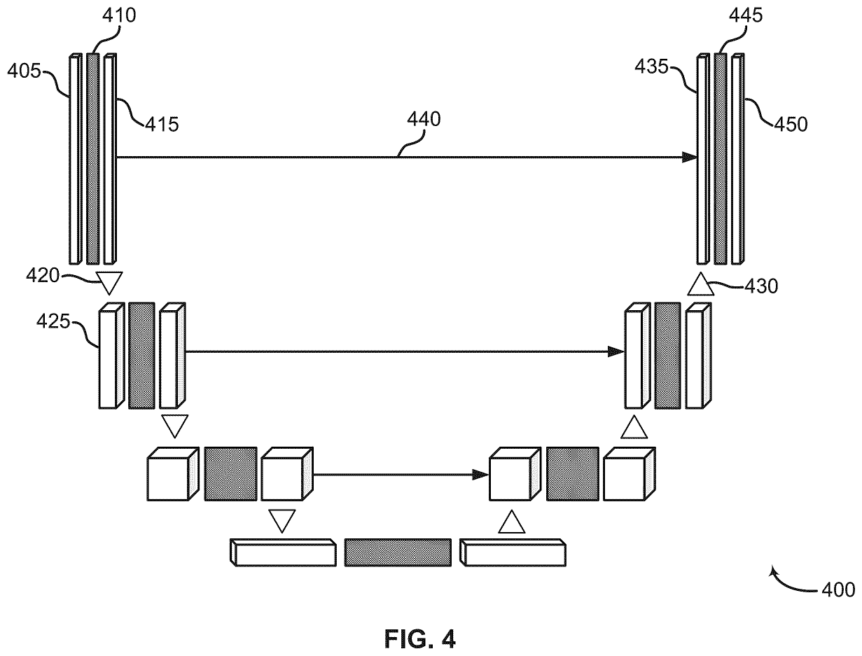

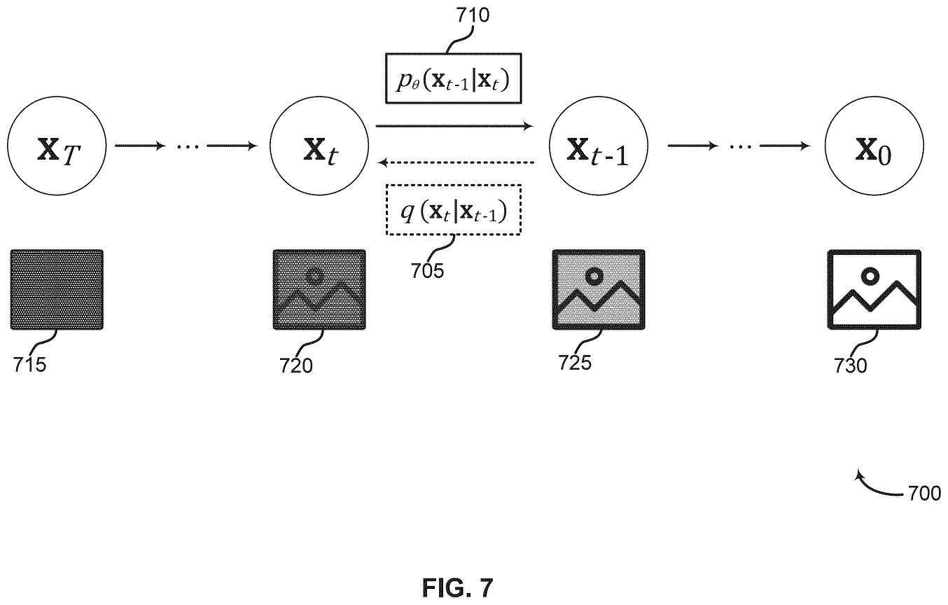

FIG. 4 shows an example of a U-Net 400 according to aspects of the present disclosure. In some examples, U-Net 400 is an example of the component that performs the reverse diffusion process 340 of guided diffusion model 300 described with reference to FIG. 3 and includes architectural elements of the image generation model 230 described with reference to FIG. 2. The U-Net 400 depicted in FIG. 4 is an example of, or includes aspects of, the architecture used within the reverse diffusion process described with reference to FIG. 7.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having a same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415.

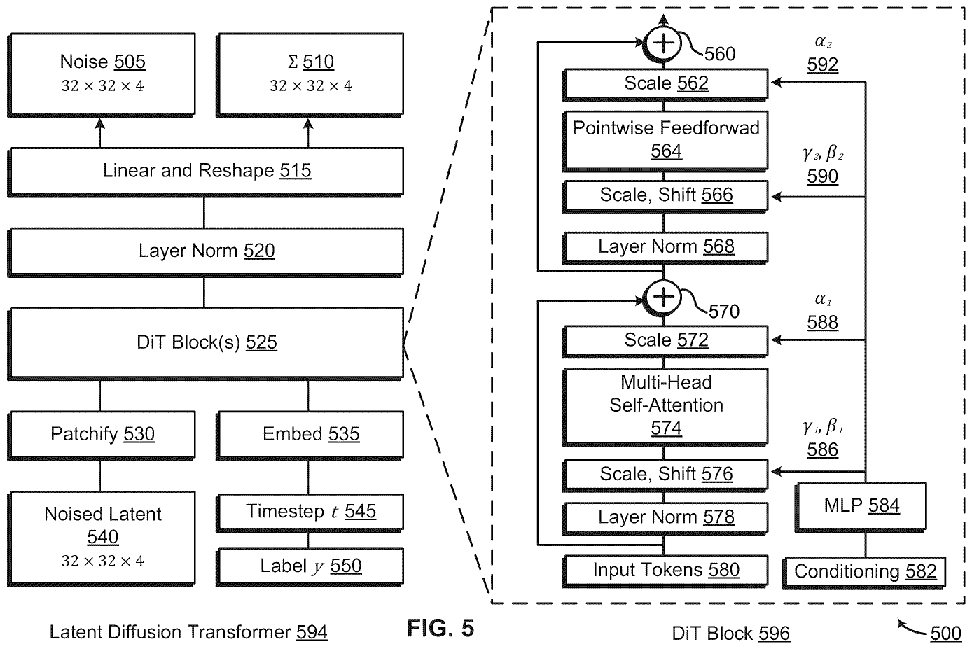

FIG. 5 shows an example of a diffusion transformer (DiT) architecture according to aspects of the present disclosure. While some generative diffusion models are based on a convolutional layer backbone (e.g., the U-Net), others may be based on a transformer network backbone.

The example shown includes predicted noise 505, predicted covariance 510, linear and reshape layers 515, normalization layer 520, DiT block(s) 525, patchify operation 530, embedding 535, noised latent 540, timestep information 545, label information 550, and an implementation of one block in the DiT block(s) 525 by a DiT Block 596. The DiT Block 596 includes: second residual connection 560, second scaling operations 562, feed-forward network 564, post-normalization second scaling and shifting 566, second normalization 568, first residual connection 570, first scaling operations 572, self-attention 674, post-normalization first scaling and shifting 576, first normalization 578, input tokens 580, conditioning tokens 582, multi-layer perceptron (MLP) 584, post-normalization first scaling and shifting parameters 586, first scaling parameter 588, post-normalization second scaling and shifting parameters 590, and second scaling parameter 592. In some embodiments, the architecture uses a Latent Diffusion Transformer 594. In some embodiments, DiT Block 596 uses an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, external visual information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 500, in some cases, uses a Latent Diffusion Transformer 594. The architecture 500 processes noised latent 540, which may be a noised version of an input image encoded in a latent space. Patchify operation 530 divides the noised latent into a sequence of patches that are processed as tokens. The tokens are vector representations of each patch of the image in latent space and are adjusted through attention processes. Each of the tokens also receives timestep information 545 and label information 550 and, accordingly, their embedding 535, which encodes the current denoising timestep and class labels as conditional information. In some cases, embedding 535 is referred to as conditional embedding or conditional information embedding. In some cases, a positional embedding which encodes each token's spatial position in the image is applied to the patchified input tokens at the patchify operations 530. In some examples the positional embedding is ViT frequency-based positional embedding. The input tokens 580 generated by the patchify operation 530 and the conditioning tokens 582 generated by the embedding 535 are processed through N DiT block(s) 525, where N may be 52, 24 or 28. Other values of N may be used. In some cases, conditional tokens refer to tokens generated based on embedding 535 encoding timestep information 545 and label information 550.

Each of the DiT block(s) 525 includes multiple processing stages. DiT Block 596 illustrates an embodiment of one block in the DiT block(s) 525. In some embodiments, the DiT Block 596 is an example of, or includes aspects of, the adaLN-Zero block. In some cases, input tokens 580 interact with the conditioning tokens 582 through multiple attention mechanisms. Particularly, after first normalization 578 applied to the input tokens and MLP 584 to the conditional tokens, MLP 584 generates or updates post-normalization first scaling and shifting parameters 586, denoted as γ₁, β₁, for post-normalization first scaling and shifting 576 to scale and shift the output of first normalization 578 accordingly. As the normalized input tokens obtained from first normalization 578 are scaled and shifted at post-normalization first scaling and shifting 576 using the conditional information carried as least in γ₁, β₁, this allows the input information and conditional information to interact. Self-attention 574 allows the scaled and shifted normalized input tokens, namely the output from post-normalization first scaling and shifting 576, to attend to each other. MLP 584 also generates or updates first scaling parameter 588 denoted as α₁ for first scaling operations 572 to scale the output of self-attention 574 (e.g., multi-head self-attention), further interacting the input information and conditional information. The input tokens 580 is then summed with the output of first scaling operations 572 at first residual connection 570. In some examples, α₁ has initial values 0, and the DiT Block 596 is initialized as the identity function.

A similar process is performed in a second half of the DiT Block 596. MLP 584 generates or updates post-normalization second scaling and shifting parameters 590, denoted as γ₂, β₂, for post-normalization second scaling and shifting 566 to scale and shift the output of second normalization 568 accordingly. As the output from second normalization 568 is scaled and shifted using the conditional information carried at least in γ₂, β₂, this allows the input information and conditional information to further interact. Feed-forward network 564 then processes the scaled and shifted output from post-normalization second scaling and shifting 566. MLP 584 also generates or updates second scaling parameter 592 denoted as α₂ for second scaling operations 562 to scale the output of feed-forward network 564, further interacting the input information and conditional information. In some cases, the feed-forward network 564 is a pointwise feed-forward network. The output from first residual connection 570 is then summed with the output of second scaling operations 562 at second residual connection 560, and the result is the final output of DiT Block 596. In some examples, α₂ has initial values 0, and the DiT Block 596 is initialized as the identity function. This process repeats for each DiT block in the sequence.

After processing through all DiT block(s) 525, the outputs undergo normalization layer 520 followed by linear and reshape layers 515. The final output is the predicted noise 505, which represents the model's prediction of the noise that was added to initially create the noised latent 540, and the predicted covariance 510, which represents the model's prediction of the covariance. The predicted noise 505 is removed from noised latent 540 at each diffusion timestep, and the predicted covariance may affect how noise is removed or resampled in the reverse or denoising process. At the end of the denoising schedule, the latent sample is decoded to generate the synthetic image in pixel space.

Image Editing with 3D Transformations

FIG. 6 shows an example of a pipeline for editing images with 3D transformations according to aspects of the present disclosure. The example shown includes input image 600, optional object selection 605, 3D instruction 610, 3D modelling network 615, 3D object shape 620, 3D editing component 625, 3D guidance image 630, mask 635, image generation model 640, and synthetic image 645.

Input image 600 is an example of, or includes aspects of, the corresponding element described with reference to FIG. 1. 3D instruction 610 is an example of, or includes aspects of, the corresponding element described with reference to FIG. 1. 3D modelling network 615 is an example of, or includes aspects of, the corresponding element described with reference to FIGS. 2 and 9. 3D editing component 625 is an example of, or includes aspects of, the corresponding element described with reference to FIG. 2.

3D guidance image 630 is an example of, or includes aspects of, the corresponding element described with reference to FIG. 11. Mask 635 is an example of, or includes aspects of, the corresponding element described with reference to FIG. 11. Image generation model 640 is an example of, or includes aspects of, the corresponding element described with reference to FIGS. 2 and 11. Synthetic image 645 is an example of, or includes aspects of, the corresponding element described with reference to FIG. 1.

In this example, the 3D modelling network 615 receives input image 600, optional object selection 605, and 3D instruction 610. As described above, the 3D instruction 610 may indicate a desired transformation of the object in input image 600, and may be, for example, a natural language instruction or a selection or input made via a GUI element. The optional object selection 605 may indicate the object to be transformed. In some cases, the system may use image segmentation techniques to obtain the selection, or the user may specify the selection.

The 3D modelling network 615 then processes the inputs to generate 3D object shape 620. The 3D object shape 620 represents the complete geometry of the object, including potentially unseen parts that would become visible after applying the transformation. Techniques for generating 3D shapes from 2D images are described with reference to FIG. 2. The 3D editing component 625 may interpret 3D instruction 610 to obtain a transformation matrix and apply the transformation to 3D object shape 620 to obtain a transformed shape. In this example, the transformed shape is the 3D object shape 620 rotated 180° about the y-axis, where the y-axis is the vertical axis on the plane of input image 600. The 3D editing component 625 may rasterize (e.g., project from 3D shape data to 2D-pixel data) the transformed shape onto input image 600 to obtain 3D guidance image 630. During this rasterization process, the component handles occlusions where certain parts of the object may obscure others and may apply texture information from the input image to maintain surface details in the guidance image.

According to some aspects, the system first sets the pixels corresponding to the object in the input image 600 to black before the rasterization/paste process. The system may further prepare mask 635. According to some aspects, mask 635 is a grayscale, pixel-wise mask that includes 0-values (e.g., black) to indicate the hole left by removing the original object, 0.5-values (e.g., gray) to indicate the region occupied by the transformed 3D shape in the 3D guidance image, and 1.0-values (e.g. white) to indicate the original background pixels from input image 600.

Then, image generation model 640 processes the 3D guidance image 630 and the mask 635 to generate synthetic image 645, which depicts the object from input image 600 after the 3D transformation, which harmonized lighting and composition, and plausible details not originally depicted in the input image 600. Additional detail regarding an image synthesis process is provided with reference to FIGS. 3-5 and FIG. 7. The resulting synthetic image 645 maintains the identity and key visual characteristics of the original object despite the significant 3D transformation and ensures consistency with the input image.

According to some aspects, the image generation model 640 is specifically trained to interpret this particular format of 3D guidance image and mask. Additional details regarding training are provided with reference to FIGS. 9-11 and 13-14. The image generation model 640 is able to infer and generate reasonable appearances for previously occluded regions by leveraging knowledge gained from its training on diverse real-world data.

FIG. 7 shows a diffusion process 700 according to aspects of the present disclosure. In some examples, diffusion process 700 describes an operation of the image generation model 230 described with reference to FIG. 2, such as the reverse diffusion process 340 of guided diffusion model 300 described with reference to FIG. 3. According to some aspects, the diffusion process can also be used in the generation of sounds and videos.

As described above with reference to FIG. 3, using a diffusion model can involve both a forward diffusion process 705 for adding noise to an image (or features in a latent space) and a reverse diffusion process 710 for denoising the images (or features) to obtain a denoised image. The forward diffusion process 705 can be represented as q(xₜ|xₜ₋₁), and the reverse diffusion process 710 can be represented as p(xₜ₋₁|xₜ). In some cases, the forward diffusion process 705 is used during training to generate images with successively greater noise, and a neural network is trained to perform the reverse diffusion process 710 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network such as a U-Net based ANN or a DiT may be trained to perform the reverse process. During the reverse diffusion process 710, the model begins with noisy data x_{T}, such as a noisy image 715 and denoises the data to obtain the p(xₜ₋₁|xₜ). At each step t−1, the reverse diffusion process 710 takes xₜ, such as first intermediate image 720, and t as input. Here, t represents a step in the sequence of transitions associated with different noise levels. The reverse diffusion process 710 outputs xₜ₋₁, such as second intermediate image 725 iteratively until x_{T} reverts back to x₀, the original image 730. The reverse process can be represented as:

p_{θ}(xₜ₋₁|xₜ):=N(xₜ₋₁;μ_{θ}(xₜ,t),Σ_{θ}(xₜ,t)) (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(xₜ)=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x, represents an original input image with low image quality, latent variables x₁, . . . , x_{T} represent noisy images, and x represents the generated image with high image quality.

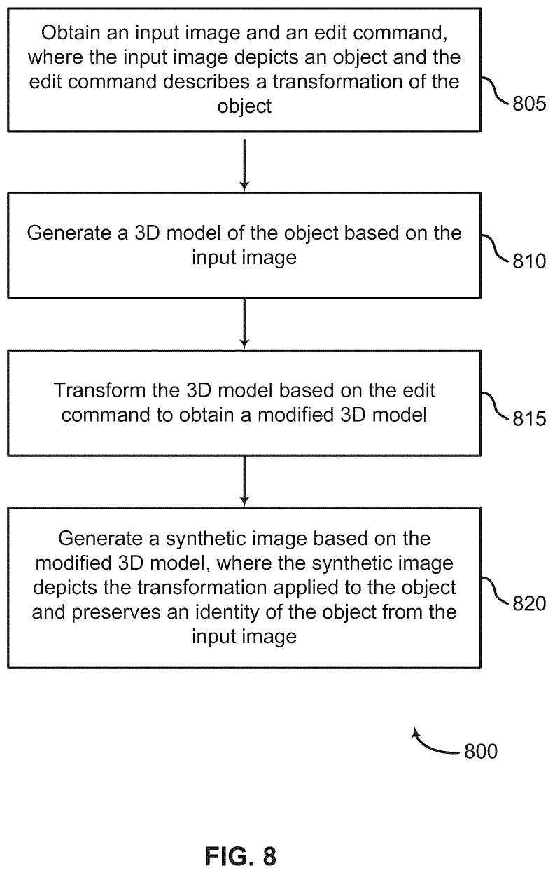

FIG. 8 shows an example of a method 800 for generating a synthetic image depicting a 3D edit according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains an input image and an edit command, where the input image depicts an object and the edit command describes a transformation of the object. The input image may be received from various sources, such as a user upload, a camera capture, or a selection from an image database. The edit command may be received through various interfaces including natural language instructions, GUI interactions, direct parameter input, or interactive manipulation of the object within a viewer. The system may also obtain information identifying which object within the image should be edited, either through user selection or automated segmentation techniques. In some cases, the operations of this step refer to, or may be performed by, an image processing apparatus as described with reference to FIGS. 1 and 2.

At operation 810, the system generates a 3D model of the object based on the input image. The 3D model can be generated using a using a 3D modelling network trained to generate a 3D model based on an image. In some cases, a diffusion model is used to generate the unseen content based on the 2D input.

In some embodiments, this process involves analyzing the 2D image to infer the complete 3D structure of the object, including parts that may not be visible in the original view. The system may employ single-view reconstruction techniques that use priors about object shapes and structures to generate a coherent 3D representation, such as a mesh, point cloud, or another suitable format. In some cases, the operations of this step refer to, or may be performed by, a 3D modelling network as described with reference to FIGS. 2, 6, and 9.

At operation 815, the system transforms the 3D model based on the edit command to obtain a modified 3D model. For example, the 3D model can be edited using an editing algorithm, or 3D editing software. The system interprets the edit command to derive appropriate transformation parameters, such as rotation angles, translation vectors, or scaling factors. These parameters are used to construct a transformation matrix that is applied to the 3D model. The transformation may involve rotating the object out of the image plane, translating it to a new position, changing its scale, or a combination of these operations. In some cases, the operations of this step refer to, or may be performed by, a 3D editing component as described with reference to FIGS. 2 and 6.

At operation 820, the system generates a synthetic image based on the modified 3D model, where the synthetic image depicts the transformation applied to the object and preserves an identity of the object from the input image. The system first creates a 3D guidance image by rasterizing the modified 3D model into the context of the original image, along with a mask indicating the original object location, the transformed object region, and the unchanged background. The image generation model has encoded knowledge of occluded portions of objects, allowing it to realistically synthesize previously unseen parts of the object that become visible after transformation.

According to some aspects, this capability is due in part to its pretraining as a video foundation model. For example, the video training data may include views of realistic objects that change over time, and the model may further learn to correspond these changes in views with 3D transformation instructions with a specialized training process that is described in greater detail with reference to FIGS. 9-11. The resulting synthetic image maintains the object's identity characteristics, such as color, texture, and distinctive features, while accurately representing its new pose or position with proper lighting, shadows, and seamless integration with the background. In some cases, the operations of this step refer to, or may be performed by, an image generation model as described with reference to FIGS. 2, 6, and 11.

### Training and Results

FIG. 9 shows an example of a training data generation pipeline according to aspects of the present disclosure. The example shown includes video data 900, sample frames 905, optical flow 910, source frame 915, target frame 920, 3D modelling network 925, source mesh 930, transform estimation 935, target mesh 940, paste to target 945, first guidance image 950, first mask 955, paste to source 960, second guidance image 965, and second mask 970.

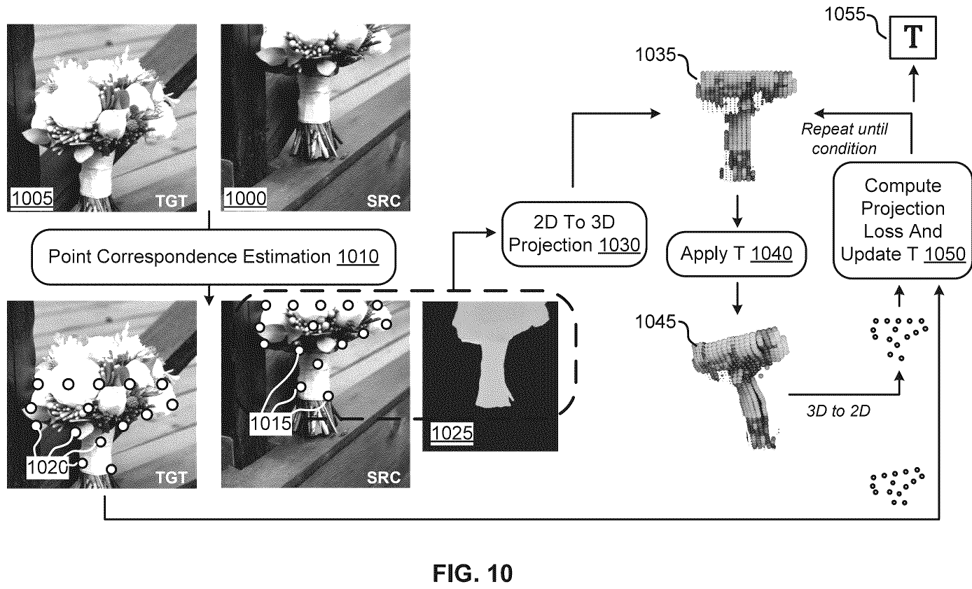

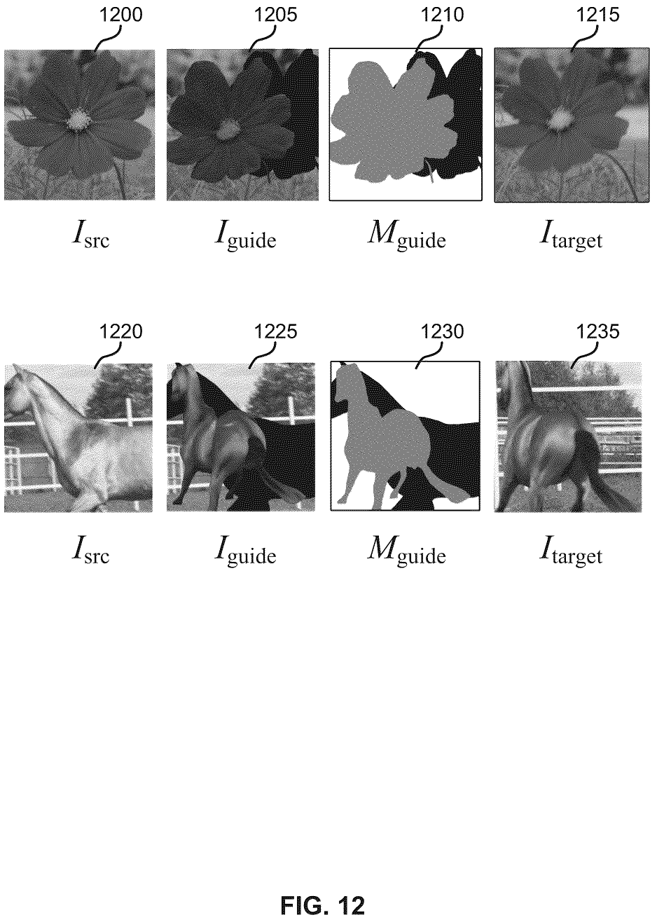

Source frame 915 and target frame 920 are examples of, or include aspects of, the corresponding elements described with reference to FIGS. 10 and 11. 3D modelling network 925 is an example of, or includes aspects of, the corresponding element described with reference to FIGS. 2 and 6. First mask 955 and second mask 970 are examples of, or include aspects of, the corresponding elements described with reference to FIG. 12.

In this example, the system obtains training data that includes frames from videos. Video training data naturally includes multiple images of objects at different positions and from different perspectives. The system selects sample frames 905 from video data 900 and may compute an aggregation of optical flow 910 over the frames. In some cases, if the optical flow 910 doesn't meet a minimum threshold over sample frames 905, then the frames are rejected as a training sample. If the sample frames 905 meet or exceed the optical flow threshold, then the system selects the beginning frame as source frame 915 (e.g. I_{src}) and the end frame as target frame 920 (e.g. I_{tgt}).

The system then may compute 3D shapes of the object from source frame 915 and the target frame 920. For example, the system may compute a source mesh 930 (e.g. S_{src}) and a target mesh 940 (e.g. S_{tgt}). The system may use a 3D modelling network as described with reference to FIG. 2. Embodiments of the 3D modelling network include a Zero-1-to-3 model to generate multi-view images and then employs a 2D to 3D model such as InstantMesh to compute reconstructed meshes.

The system may then perform transform estimation 935 to estimate the transformation matrix T that could be used to transform the source mesh 930 to target mesh 940. This estimation process may be iterative and will be described in greater detail with reference to FIG. 10.

The system may include two sub-pipelines for generating training data. These complementary approaches, referred to as “Transform Source” and “Transform Target,” both generate training tuples that teach the image generation model how to perform 3D transformations on objects. Each pipeline creates paired examples showing how an object should appear before and after a specific 3D transformation. In both approaches, the system leverages the fact that two frames from a video naturally show the same object from different perspectives or positions, providing real-world examples of transformations. The system uses these frame pairs to estimate the 3D transformation T that would move the object from its position in the source frame to its position in the target frame. By using both approaches, the system obtains diverse training examples of the same transformation from complementary perspectives which both enhancing the model's ability to generalize to various objects and scenarios. According to some aspects, the training tuples include the source image, a guidance image showing the transformed object, a mask indicating relevant regions, and the target image showing the ground truth result. The mask image The representation of the mask image is described in greater detail with reference to FIG. 6. Through these examples, the model learns to translate an object as depicted in a source frame to match its appearance in a target frame while maintaining visual consistency.

The “Transform source” sub-pipeline applies T directly to source mesh 930 (e.g., using a 3D editing component as described with reference to FIG. 2) to obtain a transformed source mesh which is rendered (sometimes referred to herein as “rasterized”) and pasted to target frame 920 (e.g., the process paste to target 945) to obtain first guidance image 950 and first mask 955. The “Transform target” sub-pipeline applies the transformation T, in contrast, directly uses the target mesh 940 and by rendering it onto the source frame 915 (e.g., the process paste to source 960). This approach leverages the already-appropriate position and orientation of the target mesh, but benefits from representing it as a 3D shape with simplified textures. This encourages the image generation model to learn to generate realistic details from relatively simple 3D guidance. The result is second guidance image 965 and second mask 970. Both sub-pipelines produce training tuples containing the source image, a guidance image, the corresponding mask, and the target image. These complementary approaches show the model different perspectives on the same transformation concept, which improves its ability to handle various objects and scenes.

FIG. 10 shows an example of a transform estimation pipeline according to aspects of the present disclosure. The example shown includes source frame 1000, target frame 1005, point correspondence estimation 1010, source frame 2D points 1015, target frame 2D points 1020, depth image 1025, 2D to 3D projection 1030, source frame 3D points 1035, apply T 1040, estimated target frame 3D points 1045, compute projection loss and update T 1050, and final T 1055. Source frame 1000 and target frame 1005 are examples of, or include aspects of, the corresponding elements described with reference to FIGS. 9 and 11.

FIG. 10 illustrates a more detailed pipeline of the “transform estimation” operation mentioned in FIG. 9. The operations of this pipeline may be performed by a 3D modelling network and a 3D editing component as described with reference to FIG. 2. According to some aspects, to estimate a plausible transformation T that can be used to transform from a source mesh S_{src} to a target mesh S_{tgt}, embodiments may first perform point correspondence estimation 1010 compute N correspondence points p_{src} (source frame 2D points) and p_{tgt} (target frame 2D points) between source frame 1000 (I_{src}) and target frame 1005 (I_{tgt}). In some cases, embodiments may further compute visibility maps v_{src} and v_{tgt} that represents the object's visibility in the frames (e.g., the visibility map may indicate if any portion of the object is cut off). Embodiments may further compute depth images D_{src} (e.g., depth image 1025) from S_{src} and D_{tgt} from S_{tgt}. The depth images indicate the distance of each point of the object from a camera's perspective at every pixel location in the image.

The system uses depth image 1025 (derived from the source mesh) to perform 2D to 3D projection 1030. This operation transforms the 2D correspondences into source frame 3D points 1035 using the backprojection formula described in equation (3). The backprojection leverages the depth value at each pixel location to determine how far the point extends in 3D space from the camera. Accordingly, embodiments may “backproject” the 2D points into 3D space:

P_{src}=Π⁻¹(p_{src},D_{src},K),

P_{tgt}=Π⁻¹(p_{tgt},D_{tgt},K), (3)

where Π⁻¹ denotes the backprojection operation and K∈ [symbol] ^{3×3} is the intrinsic camera matrix. The 3D points P∈ [symbol] ³ may be calculated as:

$$P = D ( p ) \cdot {K}^{- 1} [ \begin{matrix}{p}_{x} \\ {p}_{y} \\ 1\end{matrix} ] \qquad ( 4 )$$

where D(p) is the depth at pixel p=(pₓ, p_{y}).

Embodiments may initialize the translation component of the transformation matrix T as the centroid offset between the two point clouds:

$$t = {c}_{tgt} - {c}_{src} , c = \frac{1}{N} {\sum }_{i = 1}^{N} {P}_{i} \qquad ( 5 )$$

where t is the translation component of T and c is a centroid of a 3D shape. To initialize the rotation, embodiments may perform a coarse grid search jointly over the X, Y, and Z axes. For example, embodiments may use a step size of 10° within the range of [0°, 360°]. Once the system has established source frame 3D points 1035 and initialized T, it begins an iterative optimization process. The current estimation of transformation matrix T is applied to these points at “apply T” 1040, producing estimated target frame 3D points 1045. These points represent the system's current prediction of where the source points should be positioned in 3D space to match the target frame. At “compute projection loss and update T” 1050, the system projects the estimated target frame 3D points 1045 back to 2D and compares them with the actual target frame 2D points 1020. Embodiments may iteratively update and optimize T by minimizing a projection loss, such as an L2 loss that compares the 2D points such as:

$${ℒ}_{projection} = {\sum }_{i = 1}^{N} {‖ {p}_{tgt , i} - \prod ( {TP}_{src , i} , K ) ‖}_{2}^{2} \qquad ( 6 )$$

where Π denotes the projection operation:

Π(P,K)=[K0]P (7)

Embodiments may iteratively update T until convergence or until a predetermined number of steps is reached. The final transformation matrix accurately captures the 3D motion between the source and target frame by encoding both rotation and translation components in a single mathematical representation. The transformation estimation procedure enables the system to learn from natural object movements in video data without requiring explicit 3D annotations. By extracting these transformations from real video sequences, the training data captures authentic object appearances across various poses and lighting conditions, which significantly improves the realism of the generated synthetic images.

FIG. 11 shows an example of an image generation model training pipeline according to aspects of the present disclosure. The example shown includes target frame 1100, 3D guidance image 1105, mask 1110, source frame 1115, latent space encoder 1120, latent target frame features 1125, latent guidance image features 1130, forward diffusion 1135, latent noisy features 1140, mask reshape 1145, mask features 1150, concatenation 1155, detail extractor model 1160, detail features 1165, cross-attention 1170, image generation model 1175, and predicted noise 1180.

Target frame 1100 is an example of, or includes aspects of, the corresponding element described with reference to FIGS. 9 and 10. 3D guidance image 1105 is an example of, or includes aspects of, the corresponding element described with reference to FIG. 6. Mask 1110 is an example of, or includes aspects of, the corresponding element described with reference to FIG. 6. Source frame 1115 is an example of, or includes aspects of, the corresponding element described with reference to FIGS. 9 and 10. Image generation model 1175 is an example of, or includes aspects of, the corresponding element described with reference to FIGS. 2 and 6.

According to some aspects, embodiments train image generation model 1175 to generate realistic synthetic images that complete 3D edits as specified by 3D guidance image 1105. The structure of the image follows the guidance while preserving the identity and details of the object from source frame 1115. For regions indicated by mask 1110, the model performs different operations: inpainting missing regions (where mask value equals 0.0), modifying ambiguous regions (where mask value equals 0.5), and preserving content and identity in confident regions (where mask value equals 1.0).

The example training pipeline involves two deep neural networks: the image generation model 1175 that generates the synthetic output image, and detail extractor model 1160 that extracts features from source frame 1115 to preserve fine-grained details and object identity. These networks operate within a diffusion process framework that gradually adds and removes noise from image.

The diffusion process begins with forward diffusion 1135, which progressively adds Gaussian noise to target frame 1100, resulting in latent noisy features 1140. The latent space z may have reduced spatial dimensions compared to the pixel space. For example, mask reshape 1145 may project mask 1110 into the latent space to obtain mask features 1150. The noise addition follows a predetermined noise schedule defined by parameters that control the amount of noise added at each step. As the diffusion time increases toward the final timestep, the features gradually resemble a standard Gaussian distribution.

The image generation model 1175 then learns the reverse diffusion process, where a noisy input is gradually denoised through multiple steps to produce the final synthetic image. During training, the model is optimized to predict the noise that was added during the forward process, represented as predicted noise 1180. For example:

xₜ~ [symbol] (\sqrt{αₜxₜ₋₁,}(1−αₜ)I (8)

where xₜ is the latent sample at timestep t, I is the identity matrix, and the sample begins to resemble a standard Gaussian as t increases towards a final timestep T. Here, αₜ is a term that defines the noise schedule at each timestep.

During inference, the process is initialized using a noisy version of 3D guidance image 1105 rather than random noise. For example:

x_{T}=\sqrt{α̅_{T}}I_{guide}+\sqrt{1−α̅_{T}ε} (9)

where ∈~ [symbol] (0,I) and

$${\overline{α}}_{T} = {\prod }_{s = 1}^{T} {α}_{s} .$$

This initialization ensures alignment with the guidance while bridging the gap between training and inference domains.

At each denoising step, image generation model 1175 conditions its generation on three inputs: latent guidance image features 1130, mask features 1150, and detail features 1165 extracted by detail extractor model 1160. In some embodiments, latent noisy features 1140, latent guidance image features 1130, and the mask features 1150 are concatenated via concatenation 1155 to form a combined guidance tensor that is applied separately to image generation model 1175 from detail features 1165. In some cases, to ensure compatibility with the diffusion process, noise may also be added to source frame 1115 when extracting details.

The detail extractor model 1160 extracts detail features 1165 from the noisy source image for each self-attention block in image generation model 1175. These detail features 1165 are then injected into the model through cross-attention 1170, which enables preservation of fine details from source frame 1115 during synthesis. In this mechanism, detail features 1165 are used as keys and values, while the intermediate features of image generation model 1175 act as queries. The cross-attention ensures that fine details and identity characteristics from source frame 1115 are faithfully transferred to the synthetic output.

The pipeline including image generation model 1175 is trained using the training data generated through the processes described in FIGS. 9 and 10. In some cases, the entire pipeline is trained by backpropagating losses based on the differences in predicted noise 1180 and the actual noise added by forward diffusion 1135. By learning from these examples of 3D transformations, the model develops the ability to generate photorealistic images that show objects with complex 3D edits while maintaining visual consistency with the input image.

FIG. 12 shows an example of training tuples according to aspects of the present disclosure. The example shown includes first source image 1200, first 3D guidance image 1205, first mask 1210, first target image 1215, second source image 1220, second 3D guidance image 1225, second mask 1230, and second target image 1235. First mask 1210 and second mask 1230 are examples of, or include aspects of, the corresponding elements described with reference to FIG. 9.

As described with reference to FIG. 11, an image generation model may be trained with a training tuple including a source image, a 3D guidance image, a mask, and a target image: (I_{src}, I_{guide}, M_{guide}, I_{target}). FIG. 12 illustrates a first tuple and a second tuple containing these elements.

The system may obtain training data including first source image 1200 and first target image 1215 from, e.g., training data including a video of a flower. First source image 1200 depicts the flower in a first position. The first target image 1215 depicts the flower in a second position, a bit to the left of the first position. The system generates first 3D guidance image 1205 and first mask 1210 through the process described in FIG. 10.

The training data may further include second source image 1220 and second target image 1235. Second source image 1220 depicts a horse at a first position and a first rotation angle. Second target image 1235 depicts the horse and a second position and a second rotation angle different from the first position and the first rotation angle. The system may similarly generate second 3D guidance image 1225 and second mask 1230 using the process described in FIG. 10. According to some aspects, the system trains the model to predict second target image 1235 based on second source image 1220, second 3D guidance image 1225, and second mask 1230.

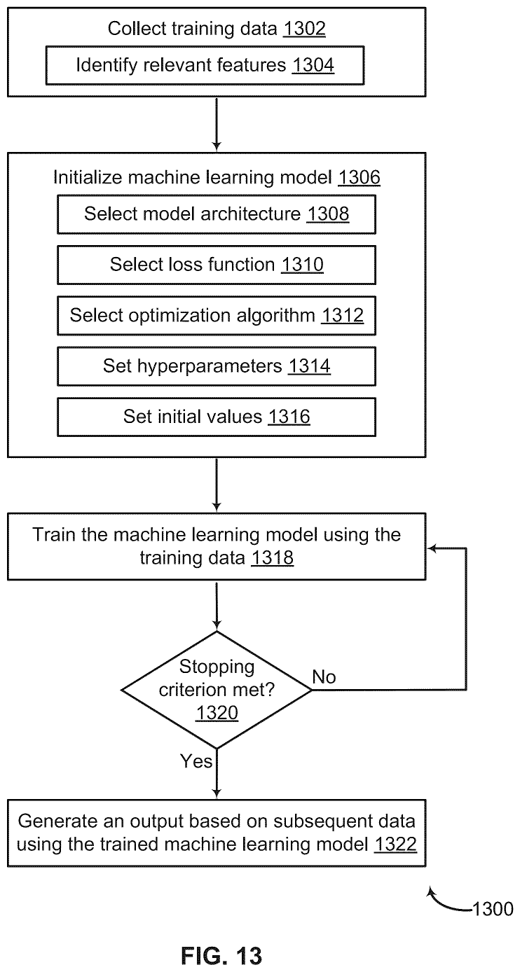

FIG. 13 is a flow diagram depicting an algorithm as a step-by-step procedure 1300 in an example implementation of operations performable for training a machine-learning model. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1306). Initialization of the machine-learning model includes selecting a model architecture (block 1308) to be trained. Examples of model architectures include neural networks, convolutional neural networks (CNNs), long short-term memory (LSTM) neural networks, transformer networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm is selected (1312) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore, once trained is configured to perform that task based on subsequent data received as an input and processed by the machine-learning model.

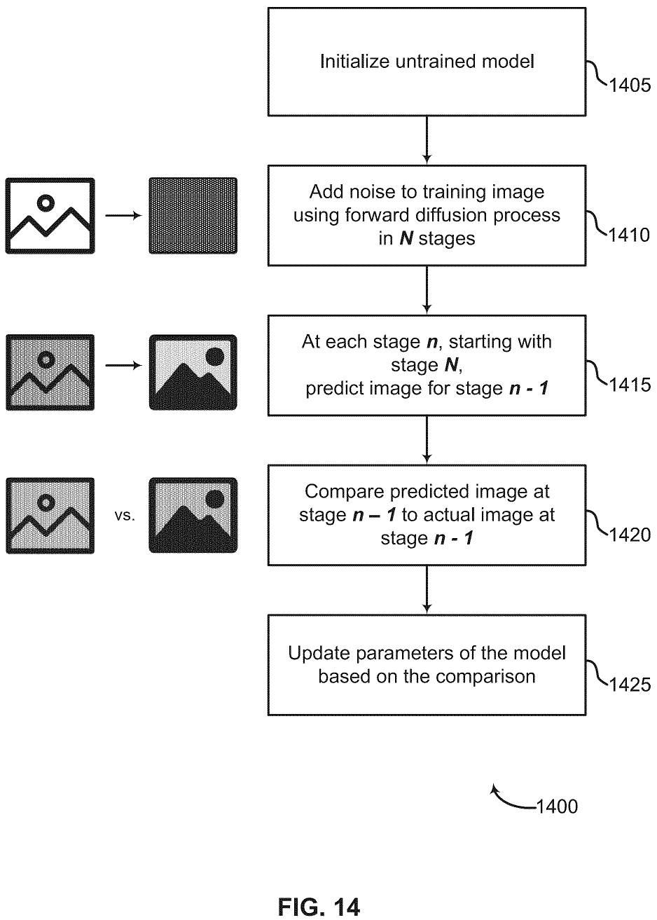

FIG. 14 shows an example of a method 1400 for training a diffusion model according to aspects of the present disclosure. In some embodiments, the method 1400 describes an operation for configuring the image generation model 230 as described with reference to FIG. 2. The method 1400 represents an example for training a reverse diffusion process as described above with reference to FIG. 7. In some examples, these operations are performed by a system including a processor executing a set of codes to control functional elements of an apparatus, such as the guided diffusion model described in FIG. 3.

Additionally or alternatively, certain processes of method 1400 may be performed using special-purpose hardware. Generally, these operations are performed according to the methods and processes described in accordance with aspects of the present disclosure. In some cases, the operations described herein are composed of various substeps or are performed in conjunction with other operations.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1415, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1420, the system compares predicted image (or image features) at stage n−1 to an actual image (or image features), such as the image at stage n−1 or the original input image. For example, given observed data x, the diffusion model may be trained to minimize the variational upper bound of the negative log-likelihood-log po (x) of the training data.

At operation 1425, the system updates parameters of the model based on the comparison. For example, parameters of a U-Net or a DiT may be updated using gradient descent. Time-dependent parameters of the Gaussian transitions can also be learned.

FIG. 15 shows an example of results from present embodiments and other approaches according to aspects of the present disclosure. The example shown includes input images 1500, 3D guidance images 1505, masks 1510, conventional results 1515, present embodiments results 1520, and ground-truth images 1525.

In some cases, other approaches fail to accurately represent 3D transforms due to insufficiencies in their training process. For example, the training process may rely on synthetic data of objects, such as manually modeled shapes made by human experts via software tools, in contrast with the video data of real-world objects used in the training of the present embodiments. The other approaches may similarly take 3D guidance images 1505 and/or masks 1510 as guidance to their models.

As apparent from the example, conventional results 1515 depicts inaccuracies and inconsistencies after the requested transformation. For example, in the first row, the cat has been distorted so much as to be unrecognizable. In the second row, the majority of the bird has been removed from the frame. In contrast, present embodiments results 1520 depicts the cat correctly shifted to the left, as well as the bird correctly turning its head to face the viewer. The present embodiments results 1520 more closely align with their respective targets, ground-truth images 1525.

FIG. 16 shows an example of a computing device 1600 according to aspects of the present disclosure. The example shown includes computing device 1600, processor(s) 1605, memory subsystem 1610, communication interface 1615, I/O interface 1620, user interface component(s), and channel 1630.

In some embodiments, computing device 1600 is an example of, or includes aspects of, an image processing apparatus as described in FIGS. 1 and 2. In some embodiments, computing device 1600 includes one or more processors 1605 are configured to execute instructions stored in memory subsystem 1610 to obtain an input image and an edit command, wherein the input image depicts an object and the edit command describes a transformation of the object; generate a 3D model of the object based on the input image; transform the 3D model based on the edit command to obtain a modified 3D model; and generate, using an image generation model, a synthetic image based on the modified 3D model, wherein the synthetic image depicts the transformation applied to the object and preserves an identity of the object from the input image.

According to some aspects, computing device 1600 includes one or more processors 1605. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store model parameters in the form of tensors which, when combined with mathematical operations such as matrix multiplications, implement machine learning models specially configured to perform specific tasks. These parameters may correspond to the models described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1615 operates at a boundary between communicating entities (such as computing device 1600, one or more user devices, a cloud, and one or more databases) and channel 1630 and can record and process communications. In some cases, communication interface 1615 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1620 is controlled by an I/O controller to manage input and output signals for computing device 1600. In some cases, I/O interface 1620 manages peripherals not integrated into computing device 1600. In some cases, I/O interface 1620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1620 or via hardware components controlled by the I/O controller.

According to some aspects, user interface component(s) 1625 enable a user to interact with computing device 1600. In some cases, user interface component(s) 1625 include an audio device, such as an external speaker system, an external display device such as a display screen, an input device (e.g., a remote control device interfaced with a user interface directly or through the I/O controller), or a combination thereof. In some cases, user interface component(s) 1625 include a GUI.

Accordingly, the present disclosure includes the following aspects.

A method for generative image editing is described. One or more aspects of the method include obtaining an input image and an edit command, wherein the input image depicts an object and the edit command describes a transformation of the object; generating a 3D model of the object based on the input image; transforming the 3D model based on the edit command to obtain a modified 3D model; and generating, using an image generation model, a synthetic image based on the modified 3D model, wherein the synthetic image depicts the transformation applied to the object and preserves an identity of the object from the input image.

In some aspects, the transformation comprises a rotation of the object. In some aspects, the 3D model comprises a point cloud, a frame mesh, or a voxel representation.

Some examples of the method, apparatus, non-transitory computer readable medium, and system further include generating a modified object image based on the modified 3D model, wherein the synthetic image is generated based on the modified object image. In some aspects, the image generation model takes the input image, a 3D guidance image, and a masked image as input, wherein 3D guidance image includes the modified object image. In some aspects, the image generation model is trained using video data that depicts a training object in an original state and a transformed state.

Some examples of the method, apparatus, non-transitory computer readable medium, and system further include computing a transformation between the original state and the transformed state.

In some aspects, the image generation model is trained using a video frame consistency loss.

A method for generative image editing is described. One or more aspects of the method include obtaining an input image depicting an object; performing a 3D transformation of the object based on the input image to obtain a 3D guidance image; and generating, using an image generation model, a synthetic image based on the 3D guidance image, wherein the synthetic image depicts the 3D transformation of the object.

Some examples of the method, apparatus, non-transitory computer readable medium, and system further include generating a 3D model of the object based on the input image. Some examples further include transforming the 3D model based on an edit command to obtain a modified 3D model, wherein the 3D guidance image is based on the modified 3D model.

In some aspects, the 3D model comprises a point cloud, a frame mesh, or a voxel representation. Some examples of the method, apparatus, non-transitory computer readable medium, and system further include generating a modified object image based on the modified 3D model, wherein the synthetic image is generated based on the modified object image.

In some aspects, the image generation model takes the input image, a 3D guidance image, and a masked image as input, wherein 3D guidance image includes the modified object image. In some aspects, the image generation model is trained using video data that depicts a training object in an original state and a transformed state. Some examples of the method, apparatus, non-transitory computer readable medium, and system further include computing a transformation between the original state and the transformed state.

An apparatus for generative image editing is described. One or more aspects of the apparatus include a memory component; a processing device coupled to the memory component, the processing device configured to perform operations comprising: obtaining an input image and an edit command, wherein the input image depicts an object and the edit command describes a transformation of the object; generating a 3D model of the object based on the input image; transforming the 3D model based on the edit command to obtain a modified 3D model; and generating, using an image generation model, a synthetic image based on the modified 3D model, wherein the synthetic image depicts the transformation applied to the object and preserves an identity of the object from the input image.

Some examples of the apparatus, system, and method further include a 3D modelling network configured to generate the 3D model. Some examples of the apparatus, system, and method further include a 3D editing component configured to transform the 3D model. In some aspects, the image generation model comprises a video generation model. In some aspects, the image generation model comprises a diffusion model.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and an edit command, wherein the input image depicts an object and the edit command describes a transformation of the object;
generating, using a 3D modelling network, a 3D model of the object based on the input image;
transforming the 3D model based on the edit command to obtain a modified 3D model; and
generating, using an image generation model, a synthetic image based on the modified 3D model, wherein the synthetic image depicts the transformation applied to the object and preserves an identity of the object from the input image.

2. The method of claim 1, wherein:
the transformation comprises a rotation of the object.

3. The method of claim 1, wherein:
the 3D model comprises a point cloud, a frame mesh, or a voxel representation.

4. The method of claim 1, further comprising:
generating a modified object image based on the modified 3D model, wherein the synthetic image is generated based on the modified object image.

5. The method of claim 4, wherein:
the image generation model takes the input image, a 3D guidance image, and a masked image as input, wherein 3D guidance image includes the modified object image.

6. The method of claim 1, wherein:
the image generation model is trained using video data that depicts a training object in an original state and a transformed state.

7. The method of claim 6, further comprising:
computing a transformation between the original state and the transformed state.

8. The method of claim 1, wherein:
the image generation model is trained using a video frame consistency loss.

9. A non-transitory computer readable medium storing code, the code comprising instructions that, when executed by at least one processor, cause the at least one processor to perform operations comprising:
obtaining an input image depicting an object;
performing, using a 3D modelling network, a 3D transformation of the object based on the input image to obtain a 3D guidance image; and
generating, using an image generation model, a synthetic image based on the 3D guidance image, wherein the synthetic image depicts the 3D transformation of the object.

10. The non-transitory computer readable medium of claim 9, wherein performing the 3D transformation comprises:
generating a 3D model of the object based on the input image; and
transforming the 3D model based on an edit command to obtain a modified 3D model, wherein the 3D guidance image is based on the modified 3D model.

11. The non-transitory computer readable medium of claim 10, wherein:
the 3D model comprises a point cloud, a frame mesh, or a voxel representation.

12. The non-transitory computer readable medium of claim 10, the code further comprising instructions that, when executed by the at least one processor, cause the at least one processor to perform operations comprising:
generating a modified object image based on the modified 3D model, wherein the synthetic image is generated based on the modified object image.

13. The non-transitory computer readable medium of claim 12, wherein:
the image generation model takes the input image, a 3D guidance image, and a masked image as input, wherein 3D guidance image includes the modified object image.

14. The non-transitory computer readable medium of claim 9, wherein:
the image generation model is trained using video data that depicts a training object in an original state and a transformed state.

15. The non-transitory computer readable medium of claim 14, the code further comprising instructions that, when executed by the at least one processor, cause the at least one processor to perform operations comprising:
computing a transformation between the original state and the transformed state.

16. A system comprising:
a memory component;
a processing device coupled to the memory component, the processing device configured to perform operations comprising:
obtaining an input image and an edit command, wherein the input image depicts an object and the edit command describes a transformation of the object;
generating a 3D model of the object based on the input image;
transforming the 3D model based on the edit command to obtain a modified 3D model; and
generating, using an image generation model, a synthetic image based on the modified 3D model, wherein the synthetic image depicts the transformation applied to the object and preserves an identity of the object from the input image.

17. The system of claim 16, the system further comprising:
a 3D modelling network configured to generate the 3D model.

18. The system of claim 16, the system further comprising:
a 3D editing component configured to transform the 3D model.

19. The system of claim 16, wherein:
the image generation model comprises a video generation model.

20. The system of claim 16, wherein:
the image generation model comprises a diffusion model.
